(19) United States
(12) Patent Application Publication
(10) Pub. No.: US 2010/0233969 A1
(43) Pub. Date: Sep. 16, 2010

(54) RECONFIGURABLE CHAMBER FOR EMULATING MULTIPATH FADING

(75) Inventors: Jeff Frolik, Essex Junction, VT (US); Thomas Weller, Lutz, FL (US)

Correspondence Address: SMITH HOPEN, PA, 180 PINE AVENUE NORTH, OLDSMAR, FL, 34677, US

(73) Assignees: University of South Florida, Tampa, FL (US); University of Vermont, Burlington, VT (US)

(21) Appl. No.: 12/728,730

(22) Filed: Mar. 22, 2010

Related U.S. Application Data
(63) Continuation of application No. PCT/US2008/077198, filed on Sep. 22, 2008.
(60) Provisional application No. 60/973,915, filed on Sep. 20, 2007.

(51) Int. Cl. H04B 17/00

(52) U.S. Cl. 455/67.14

(57) ABSTRACT

Disclosed is a compact reconfigurable channel emulator, which may be used to emulate severe fading environments and test wireless systems and subsystems for operation in severe channel environments. Examples include radios, coding schemes, diversity methods and antennas. In particular, the chamber is well suited to test hardware associated with wireless sensor deployments for these tend to be susceptible to severe fading scenarios. Moreover, the invention is significantly smaller than traditional testing instruments, and with its automation, reduces electromagnetic interference and electromagnetic compatibility testing time and costs.

### CROSS REFERENCE TO RELATED APPLICATIONS

This application is a continuation of prior filed International Application, Serial Number PCT/US2008/077198 filed Sep. 22, 2008, which claims priority to U.S. provisional patent application No. 60/973,915 filed Sep. 20, 2007 which is hereby incorporated by reference into this disclosure.

### FIELD OF INVENTION

This invention relates to an instrument for testing electromagnetic signal fading that occurs with wireless transmitting and receiving devices.

### BACKGROUND OF THE INVENTION

In wireless communications, the presence of radiofrequency (RF) interferers surrounding a transmitter and receiver create multiple paths for a transmitted signal. This causes multiple copies of the transmitted signal, each traveling a different path, to superimpose at the receiver. Each signal copy experiences differences in attenuation, polarization change, delay, and phase shift, which results in constructive or destructive interference, amplifying or attenuating the signal power seen at the receiver. Strong destructive interference is frequently referred to as a deep fade and may result in temporary failure of communication due to a severe drop in the channel signal-to-noise ratio. Recent data collected aboard aircraft, rotorcraft, and busses indicate it is not uncommon for multipath fading within these structures to be severe. This result is not unexpected, as these environments are essentially metal cavities.

Rayleigh fading models assume a signal's magnitude, after passing through a transmission medium, will fade according to a Rayleigh distribution, a radial component of the sum of two uncorrelated Gaussian random variables. The model requires many signal scatterers, thus Rayleigh fading models are useful in heavily built urban areas where there is no dominant propagation along a line of sight between the transmitter and receiver and many buildings and other objects attenuate, reflect, refract, and diffract the signal. The fading characteristics within aircraft, rotorcraft, and busses are often found to be more severe than predicted using Rayleigh fading models. Analytical models for this fading regime, deemed hyper-Rayleigh, were developed and a two-ray model proposed for this application space. Wireless devices are typically tested in an RF chamber, which include anechoic chambers and electromagnetic reverberation chambers.

Two different radio frequency (RF) test chambers have historically been utilized to create controlled environments for testing wireless systems. The first, the anechoic chamber, is designed so that any energy incident on the chamber walls and other structures inside the chamber is absorbed and not reflected. These chambers are commonly used for electromagnetic compatibility/electromagnetic interference (EMC/EMI) testing and for antenna measurements. Unfortunately, multipath propagation between a transmitting and receiving source is non-existent for these chambers as the walls and structures are covered with energy absorbing anechoic material. Chambers are often constructed within small- to medium-sized rooms, facilitating easy installation of test equipment and also so that far field antenna performance can be measured.

Anechoic chambers are lined with a radiation absorbent material (RAM), such as carbon-impregnated foam or rubberized foam impregnated with carbon and iron. The RF anechoic chamber is typically used to house equipment for measuring antenna characteristics, radiation patterns, electromagnetic compatibility (EMC) electromagnetic interference (EMI), and radar cross-section characteristics. EMI testing is performed to analyze the properties of antennas and other electronics that are susceptible to radio or microwave interference The RAM is designed and shaped to absorb incident RF radiation from as many incident directions as possible, reducing the level of reflected RF radiation. Ideal RAM materials are neither a good electrical conductor nor insulator, but are an intermediate grade material which absorbs power gradually in a controlled way as the incident wave penetrates the RAM material. To work effectively, all internal surfaces of the anechoic chamber must be entirely covered with RAM. One of the most effective types of RAM comprises arrays of pyramid shaped pieces, which act to resist and dissipate electromagnetic waves.

Anechoic chambers vary in size, depending on the test objects and frequency range of the radio or microwave signals used. Many EMC tests and antenna radiation patterns require spurious signals arising from the test setup, including reflections, to be negligible to avoid measurement errors and ambiguities. Thus, the test setups require extra room than that required to simply house the test equipment, the hardware under test and associated cables. The costs associated with constructing an anechoic chamber are typically high, accounting for the extra test space, such as minimum distance between the transmitting and receiving antenna for far field testing, along with the extra space required for the RAM. For most companies such an investment in a large RF anechoic chamber is not justifiable unless it is likely to be used continuously or perhaps rented out.

An electromagnetic reverberation chamber, or mode-stirred chamber (MSC), is a screened room with highly reflective walls, which acts as a cavity resonator. This allows the MSC chamber to act as an environment for EMC and EMI testing and other electromagnetic investigations. Because the chamber has low absorption, very high field strength can be achieved with moderate input power. Reverberation chambers vary in size but tend to be electrically large (e.g., >60%).

The spatial distribution of the electrical and magnetical field strength is strongly inhomogeneous, due to the reflective surfaces in the MSC chamber. To reduce this inhomogenity, one or more rotating, reflective panels (or stirrers), and/or changes in the position and/or orientation of the emission source are used. The Lowest Usable Frequency (LUF) of a reverberation chamber depends on the size of the chamber and the design of the tuner. Small chambers have a higher LUF than large chambers. Mixing the modes in this manner allows test objects, in a single orientation to be exposed to EM energy in many different angles of incidence and polarization. MSC have been shown to be effective in creating time-varying environments with Ricean characteristics ranging from negligible fading to Rayleigh. This variability in fading is created through the addition or removal, respectively, of anechoic material.

However, there are currently no means to enable systems to be tested under these hyper-Rayleigh conditions in a reliable and repeatable manner.

### SUMMARY OF THE INVENTION

Disclosed is a compact reconfigurable channel emulator (CRCE), which is useful in creating a wide variety of fading scenarios within its cavity, and maximizing inhomogeneous fields. The device is a fully-automatic, bench-top sized instrument and can operate as a stand-alone fully-shielded bench-top structure or in-situ, with the outer shielding removed. In some embodiments, the device is useful in testing wireless systems and subsystems for operation in severe channel environments, like airframes. Examples include radios, coding schemes, diversity methods and antennas. In particular, embodiments of the chamber are well suited to test hardware associated with wireless sensor deployments for these tend to be susceptible to severe fading scenarios. Embodiments of the device allow detailed control of fading scenarios, thus permitting repeatable fading through fine control of the reflecting surfaces. Additionally, hyper-Rayleigh fading scenarios may be generated by some embodiments. This may allow for characterization of wireless communication devices under realistic “in the field” operating environments. The disclosed device is capable of creating in a reliable and repeatable fashion fading scenarios ranging from no fading to two ray, severe fading scenarios. This is useful in testing wireless devices for electromagnetic interference (EMI) and electromagnetic compatibility (EMC).

In some embodiments of the device, the compact reconfigurable channel emulator can operate as a stand-alone fully-shielded bench-top structure or in-situ, with the outer shielding removed. The device eliminates the need for manual repositioning of receiving and transmitting antennae during channel testing. Further, any arbitrary wireless channel condition may be recreated inside the device, enabling the user to rigorously test the wireless device.

The device comprises a test chamber of a set size. In some embodiments, the device is 3 ft×3 ft×2 ft, and is therefore physically smaller than typical anechoic or reverberation chambers. In specific embodiments, the device is used to test 2.5 and 5 GHz electromagnetic wireless bands. The device may be larger or smaller to operate in different electromagnetic spectrum. The test chamber may be constructed as an electromagnetically reflective chamber; an electromagnetically absorbent chamber, or a RAM coated chamber, through selecting appropriate materials as known in the art. Nonexclusive examples of useful materials include steel, aluminum, and copper-mesh. All are conductive and exhibit reasonably high reflection coefficients. The material may remain as thin as structurally possible. In some embodiments, the electromagnetically reflective chamber is constructed using aluminum plating joined together. The invention also offers the potential for significant cost savings over currently available technologies due to its small size, and the ability to significantly reduce testing time because of its automation features. At least one electromagnetically reflective blade is pivotally attached to the test chamber. In some embodiments, the reflective blades are attached to the ceiling of the test chamber. In certain embodiments, the reflective blades alter the multipath environment in a controlled manner. The device uses electrical switching arrays in some embodiments. Specific embodiments use a plurality of antennas in electrical contact with a power splitter, and under control of a computer. The computer generates signals within the chamber, resulting in a repeatable multipath environment. The device may use reflective blades, electrical switching arrays, or both in generating multipath scenarios. The addition or subtraction of anechoic material is utilized in certain embodiments for creating a wide range of fades. In specific embodiments the sizes of anechoic sections are minimized in thickness, to prevent cluttering the chamber. For this reason, anechoic performance may be sacrificed in place of flat (non-pyramidal), space-efficient designs.

Gaps in the chamber walls will allow signal contamination, compromising the repeatability of fading scenarios. Thus, in certain embodiments, the corners and doorway of the chamber are effectively shielded with reflective or anechoic material.

A plurality of antenna are disposed within the test chamber. The antenna are electromagnetically bound within the test chamber in some embodiments, such that signals emanating from the antenna do not radiate beyond the test chamber and electromagnetic energy does not enter the test chamber during testing. The antenna comprises at least one signal transmission antenna, at least one receiving antenna, and at least one delay transmission antenna. In each antenna, the antenna is either an antenna or a connection port for accepting an antenna and communication cable.

In embodiments using connection ports, communication lines are utilized to transmit instructions to a test device or antenna within the test chamber. In some embodiments, the test chamber is excited by a transmitting antenna, which may be a fixed antenna, cellular phone, electric monopole, a helical antenna, a microstrip patch antenna, or an antenna array. The transmitting antenna does not direct radiation directly to the receiver antenna in certain embodiments. Data is collected from a signal detection device, electrically connected to the at least one receiving antenna. The signal detection device may be a network analyzer, which in some embodiments is a vector network analyzer (VNA) that sweeps the frequency and provides S-parameters for the band of interest. VNAs useful in this device include, without limitation, the Anritsu 37000D, Anritsu MS462XB/D, Anritsu MS4630B, Agilent E8362B/HP E8362B, Agilent N5320A/HP N5230A 4-Port PNA-L, Agilent N5242A, Agilent 8510C Agilent 8719ES, Agilent E5100A, Agilent E5071C ENA, Agilent E5061A ENA-L, Agilent E5062A ENA-L Agilent 4395A, Agilent 4396B, Agilent 8757D, Agilent 89410A, Agilent 89440A, and Rohde & Schwarz ZVA series analyzers. Alternatively, the signal detection device is a wireless test device or a vector signal analyzer. Non-limiting examples of useful vector signal analyzers include Agilent 89600VSA, Agilent 89441A, Agilent HP 89440A, Agilent 89641A, E4406A, Agilent 89410A, Agilent 89611A, Agilent 4195A, Rohde &Schwarz FSQ K70, Rohde & Schwarz FSQ K90, Hewlett Packard 89440A, Keithley 2020, Keithly 2810, and Anritsu MS2690A.

The device also has the ability to add delay lines to emulate strong reflections off a distant object. The delay transmission antenna is electronically connected to the delay line, which may be constructed of coaxial line, triaxial line, twin-axial line, biaxial line, and semi-rigid line. In specific embodiments, all cables providing data to or from the test chamber are constructed of coaxial line, triaxial line, twin-axial line, biaxial line, and semi-rigid line. In some embodiments, interference ports or interference antenna are also provided, which are useful to conduct susceptibility testing. In specific embodiments of the disclosed device, the interference antennas are connected to a distribution network of switches, amplifiers, delay lines, power splitters, and combiners. Further, the electromagnetically reflective blade is attached to motor to provide fading scenarios. In some embodiments, a stepper motor used to provide discrete control to a fixed number of fading scenarios. The blade may alternatively be attached to an adjacent DC motor to create higher-rate temporal variations, a shaded pole AC induction motor, split-phase capacitor AC induction motor, AC synchronous motor, stepper DC motor, brushless DC motor, coreless DC motor, brushed DC motor, singly-fed electric motor, or a doubly-fed electric motor. The motor in the provided embodiments may rotate the stirrer at a continuous speed from 0.1 to 2.0 Hz.

In some embodiments, the motor for the reflective blades, as well as data acquisition are controlled through a personal computer. In specific embodiments, rotation of the reflective blades occurs concurrently with electronic switching of fading states, generating unique fading patterns. Alternatively, the fading patterns are generated by only the reflective blades or electronic switching. A graphical user interface (GUI), may be provided for the motor control electromagnetic signal transmission and data acquisition. Data is collected in one of two scan modes, frequency-varying or time-varying, for which the user selects a frequency range or a specific frequency for testing, respectively. Sweeps are captured from the VNA and a cumulative distribution function (CDF) of the data and statistical computation are displayed on the GUI.

The GUI also allows control of the rotation and position of the rotating blade. The blade can be rotated at a continuous speed from 0.1 to 2.0 Hz, for time-selective scanning. The blade may also be positioned at specific angles for frequency-selective scanning. The precise angle of each blade is calculated from the relative position of the blades to a “Home” position. Each 7.2° step made by the motor generates a unique fading environment, which can be recreated by setting the blade to that specific angle.

Movable objects are disposed within the device in some embodiments, such that the objects are sequentially movable during the apparatus operation. The movable objects may be a movable platform, an oscillating fan, and a wireless test device.

Also disclosed is a method of characterizing an electromagnetic communication device, using the disclosed device. A plurality of antenna in the test apparatus are placed within the device, wherein the plurality of antenna further comprise at least one transmitting antenna, at least one delay transmission antenna and at least one receiving antenna. The user then creates a fading environment within the device, as described above. The user may create fading environments through the device, including Ricean fading, Rayliegh fading, hyper-Rayliegh fading, two-ray fading, 10 dB fading, 20 dB fading, 30 dB fading, or 40 dB fading. In some embodiments, the computer controls the reflective blades, which influence fading within the device. The user may also create a fade free environment. An electromagnetic signal is then generated from the transmitting antenna to the receiving antenna, allowing the signals to be influenced by the environment. The signals are collected by the receiving antenna and the electromagnetic signal data collected. In some embodiments, movable objects are added to the device, which may include without limiting the device, a movable platform, an oscillating fan, and a wireless test device. In specific embodiments, the movable object is moved continuously during a measurement operation.

The device may collect bit error rate, frame error rate frequency-selective fading, time-selective fading, signal-to-interference ratio, time/frequency fading, spatial diversity benefits, response of equalization algorithms, power control algorithms, and frequency diversity benefits.

### BRIEF DESCRIPTION OF THE DRAWINGS

For a fuller understanding of the invention, reference should be made to the following detailed description, taken in connection with the accompanying drawings, in which:

FIG. 1 is a block diagram of an embodiment of the CRCE design, depicting the relative location of the components.

FIG. 2 is a photograph of a fabricated embodiment of the device.

FIG. 3 is a frame captured picture of the CRCE's graphical user interface. The graphical user interface for the CRCE operation. Information from the CRCE instrument is sent to a PC, and displayed on the GUI.

FIG. 4 is a block diagram of an embodiment of the CRCE, depicting the relative location of the components.

FIGS. 5(A) and (B) depict graphs of frequency-selective data collected by the device, exhibiting Rayleigh fading characteristics. (A) in-band data and (B) cumulative distribution function (CDF) are shown.

FIGS. 6(A) and (B) depict graphs of frequency-selective data collected by the device, exhibiting hyper-Rayleigh fading characteristics. (A) in-band data and (B) cumulative distribution function (CDF) are shown.

FIGS. 7(A) and (B) depict graphs of frequency-selective data collected by the device, exhibiting Ricean characteristics, showing the inband variation across the 2.40-2.48 GHz ISM band is about 12 dB. (A) in-band data and (B) cumulative distribution function (CDF) are shown.

FIGS. 8(A) and (B) depict graphs of frequency-selective data collected by the device, exhibiting hyper-Rayleigh characteristics, showing the inband variation exceeds 40 dB. An illustrative graph of frequency-selective data collected, while exhibiting hyper-Rayleigh characteristics, showing the inband variation exceeds 40 dB. (A) in-band data and (B) cumulative distribution function (CDF) are shown.

FIGS. 9(A) and (B) show graphs utilizing the data from FIGS. 5-8 depicting the unique fading scenarios generated by the device. (A) in-band data and (B) cumulative distribution function (CDF) are shown.

FIGS. 10(A) and (B) depict graphs of time-sensitive data, using Rayleigh-like characteristics, collected by the CRCE. The data show fades around 20 dB over time. A graph of time-sensitive data, using Rayleigh-like characteristics, collected by the CRCE. The data show fades around 20 dB over time. (A) in-band data and (B) cumulative distribution function (CDF) are shown.

FIG. 11 is a photograph of a fabricated embodiment of the device adapted for spatial-selective scanning.

FIGS. 12(A) and (B) show graphs of spatial fading responses in the device using three antenna modes at 50 locations. The test chamber used electromagnetically reflective walls (i.e. no anechoic material was added to the test chamber inner lining). (A) in-band data and (B) cumulative distribution function (CDF) are shown.

FIGS. 13(A) and (B) show graphs of spatial fading responses in the device using three antenna modes at 50 locations. Anechoic material was added to the test chamber inner lining. (A) in-band data and (B) cumulative distribution function (CDF) are shown.

FIGS. 14(A) and (B) show graphs of spatial fading responses in the device using three antennas to create seven discrete signal amplitudes. (A) in-band data showing 500 samples over approximately 2 seconds and (B) cumulative distribution function (CDF) are shown.

FIG. 15 is a block diagram of the CRCE design, depicting the relative location of the components using a computer controlled, 4-way interference design.

FIG. 16 is an illustration of a an electrical diagram showing the wiring schematic for the electric interference array.

FIG. 17 an illustration of a an electrical diagram showing the wiring schematic for the interference delay lines.

FIG. 18 an illustration of a an electrical diagram showing the schematic for the electrical switching array and control connection lines.

FIG. 19 an illustration of a an electrical diagram showing the electrical switch array.

FIG. 20 an illustration of a an electrical diagram showing the delay network.

FIG. 21 an illustration of a an electrical diagram showing the interference network.

### DETAILED DESCRIPTION OF THE PREFERRED EMBODIMENT

“Wall” as used herein is used to describe sidewalls of a test chamber. The chamber may have any size and shape, such as square, rectangular, trapezoidal, cylindrical regardless of the shape of the chamber. In embodiments utilizing reflecting walls, the walls are most easily provided with metal foil or plates. In at least one of the walls of the chamber there is an access door, which is closed during measurements. The chamber is typically rectangular, however, other shapes, which are easy to realize, are also envisioned. Exemplary embodiments include shapes with vertical walls and flat floor and ceiling and with a horizontal cross-section that forms a circle, ellipse, square, rectangle or other polygon.

As used herein, a “wireless test device” is any device utilizing electromagnetic fields to transmit or receive data. This includes, without limitation, remote controls, mobile phones, including cellular phones and cordless phones, wireless LAN, including Wi-Fi hotspot, Bluetooth devices, portable two-way radio communications, walkie-talkies, wireless security systems, radio data communications, and child monitors.

As used herein, an “electrical switching array” is an electromagnetic transmission system adapted to transmit data. The electrical switch array is used, in specific examples, to provide additional multipath scenarios or to increase wireless signal interference. The array may comprise, without limiting the invention, remote controls, mobile phones, including cellular phones and cordless phones, wireless LAN, Bluetooth devices, portable two-way radio communications, walkie-talkies, wireless security systems, radio data communications, transmission antenna. In some embodiments, the electrical switching array is a plurality of devices. A computer may control the transmission and signal characteristics of the devices in specific embodiments.

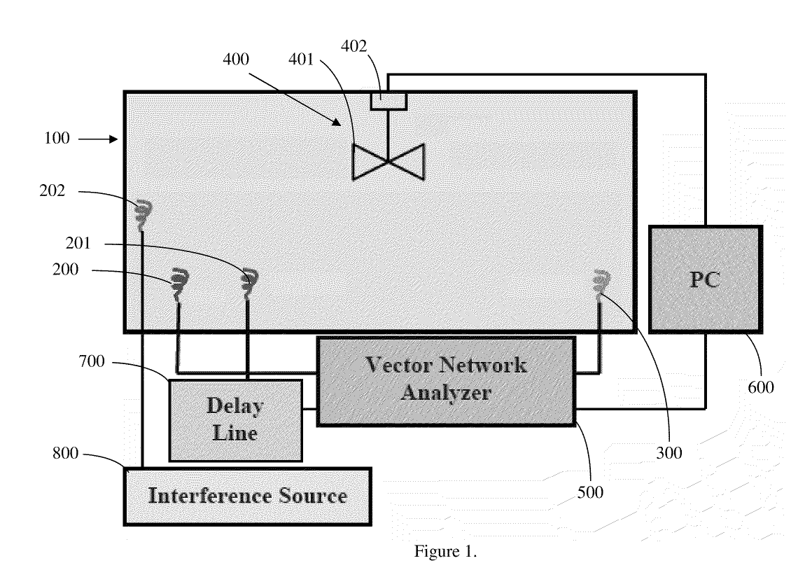

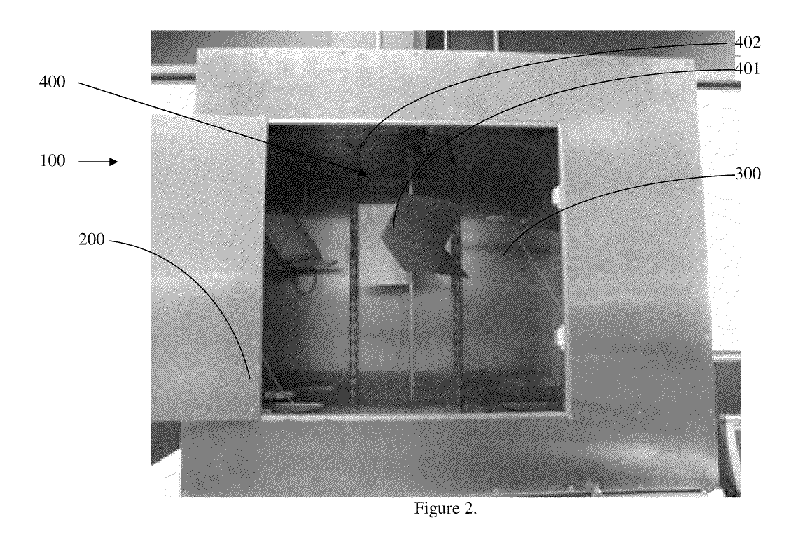

A compact reconfigurable channel emulator is depicted in FIG. 1, wherein test chamber 100 is constructed of continuously welded aluminum panels, seen in FIG. 2. Alternatively, test chamber 100 is constructed of wood, cement, Plexiglas, lexan, glass, or other metals. Test chamber 100 is, in some embodiments, encapsulated in conductive mesh, conductive plates, or other material suitable to construct a Faraday cage around the test chamber. Test chamber 100 is a three foot by two foot by three foot box, which corresponds to 7.3λ×4.8λ×7.3λ for a 2.4 GHz test frequency. A plurality of antenna are provided in the device. The plurality of antenna used are long-wire antenna in the 900 MHz to 5.0 GHz range, and may be antenna operating at 2.4 GHZ or 5.0 GHz. The antennas are alternatively double ridged horn antenna in the 1.0 GHz to 40 GHz range, biconical antenna, dipole antenna, or plate antenna. Signal transmission antenna 200 is suspended in test chamber 100 such that signal transmission antenna 200 does not physically contact the walls of test chamber 100, and is position able by a user to the desired location in the test chamber. A delay transmission antenna 201 is likewise suspended in test chamber 100, and electrically connected to delay line 700. Receiving antenna 300 is suspended in test chamber 100 and is position able by a user to the desired location in the test chamber. In some embodiments, signal transmitting antenna 200 is disposed at a location within test chamber 100 opposite receiving antenna 300.

Stirrer 400 comprises a plurality of electromagnetically reflective blades 401 attached to motor 402 by a rotating armature. Stirrer 400 is suspended from the roof of test chamber 100, at the center of the chamber ceiling. Reflective blades 401 are rotated by motor 402 under the control of a motor indexer and computer 600. Rotation of reflective blades 401 mixes wave impedance within test chamber 100. The fields generated in the test chamber 100 are thus homogeneous and isotropic, allowing test equipment to be placed anywhere in test chamber 100 and receive fields from all directions.

A test and control GUI, Labview, loaded on computer 600 allows control of the rotation and position of reflective blades 401. In some embodiments, motor 402 is a stepper motor. The blades can be rotated at a continuous speed from 0.1 to 2.0 Hz, for time-selective scanning, or positioned at specific angles for frequency-selective scanning. The precise angle of each blade is calculated from the relative position of the blades to a “Home” position. Each 7.2° step made by the motor generates a unique fading environment, which can be recreated by setting the blade to that specific angle. Alternatively, motor 402 is a DC motor to create higher-rate temporal variations.

Signal detection device 500, is a vector network analyzer, such as an Agilent MS2036ZA or Anritsu MS2036A VNA Master, in electrical contact with receiving antenna 300 and sweeps radio frequencies and provides S-parameters for the band of interest between 2.40-2.48 GHz. In certain embodiments, the VNA which sweeps the frequency and provides S21 data for the band of interest between 2.40-2.48 or 5.00-5.08 GHz. In some embodiments, vector network analyzer 500 includes a frequency synthesizer or sweep oscillator frequency synthesizer for providing a test frequency source signal. The source signal from a sweep oscillator is amplified using a radio frequency power amplifier. In some embodiments, at least one fixed coaxial delay line 700 is used to emulate strong reflections off a distant object. Alternatively, delay line delay line 700 is constructed of fiber optic cable or other material adapted to not generate external electromagnetic waveforms, which include by non-limiting examples triaxial line, twin-axial line, biaxial line, semi-rigid line, and photonic crystal fiber line. The signal from a frequency synthesizer is split and sent to the signal transmission antenna and to delay line 700 and to delay transmission antenna 201.

In some embodiments, interference ports are provided to conduct susceptibility testing. The interference ports allow signals from interference source 800 to excite interference transmission antenna 202, thereby generating at least one interference waveform within test chamber 100. Communication lines between interference source 800 and interference transmission antenna 202 are adapted to not generate external electromagnetic waveforms, such as coaxial cables or fiber optic cables.

The present device may include additional obstacles may be placed into test chamber 100 to alter the fading environment. For example, electromagnetically reflective panels 900 may be placed inside the test chamber to add signal reflections and increase signal travel time from the signal transmission antenna to the receiving antenna. Further, oscillating fan 901 may be placed in the test chamber to create high-rate temporal variations, like those seen in a rotocraft.

In situations where the device is used to test equipment, the test device may replace signal transmission antenna 200, for transmission testing of the test device, or replace receiving antenna 300 for signal receiving testing. The test device is placed at the center of test chamber 100, at least three inches above the floor, and should also be electrically isolated from test chamber 100 during testing. In some embodiments, a field monitoring probe is placed close to the test device. The test equipment response is thus monitored by the field monitoring probe and communicated through cables which are routed through conventional access panels or a port within test chamber 100. Communication cables are adapted to not generate external electromagnetic waveforms, such as coaxial cables or fiber optic cables.

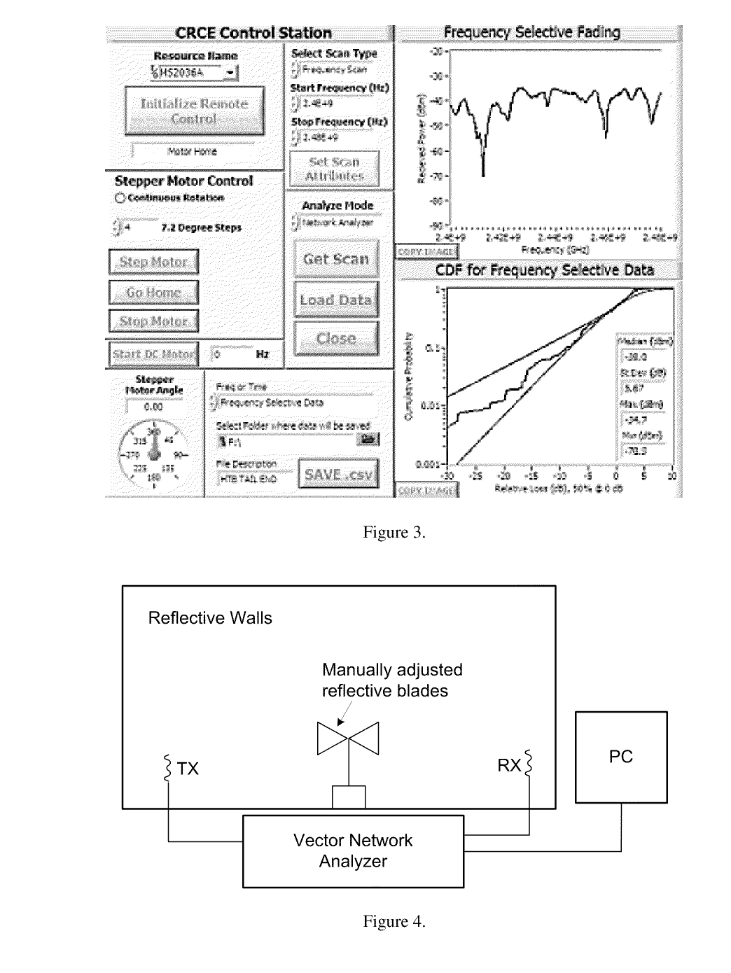

Data acquisition is controlled through a personal computer using a graphical user interface GUI, showing in FIG. 3. Data is collected in one of two scan modes, frequency-varying or time-varying, for which the user selects a frequency range or a specific frequency for testing, respectively. Sweeps are captured from the VNA and a cumulative distribution function (CDF) of the data and statistical computation are displayed on the GUI.

In specific embodiments, the GUI remotely configures the scan attributes for the VNA (i.e., start/stop frequency). The GUI is also utilized to control the rotation and position of the rotating blade. The blade can be rotated continuously at speeds varying from 0.1 to 2.0 Hz for the time-selective scan, or positioned at specific angles for the frequency-selective scan. For accurate repeatability of the fading environments, the precise angle of the blade should be known. Therefore, all angle positions are created by a stepper motor, calibrated to a known “Home” position. Specific embodiments allow a 7.2° step, generating 50 unique fading environments. This same fading environment can be recreated whenever the blade is sent back to that specific angle.

An “AutoScan” feature allows the system to capture and record VNA data for each position of the stepper motor. When complete, the user can view each fading scenario accomplished one at a time, or all at once. The program will appropriately position the stepper motor to recreate any of these scenarios, if selected. This eliminates the need to view each fading response one at a time while looking to create a specific environment. However, if anything is moved within the chamber (antenna or addition/subtraction of anechoic material) the accurate recreation of previous fading environments is unlikely.

Table 1 presents the overall impact of anechoic foam on CRCE performance. The high multipath case, created through lack of foam, resulted in Rayleigh-like behavior with equal probability of Ricean and hyper-Rayleigh cases. The range, however, is limited as there are virtually no cases of benign or two-ray scenarios. When anechoic foam was included, multipath became limited and the majority of fading environments was Ricean. The probability of Rayleigh and hyper-Rayleigh decreased, but there are now more extreme fading profiles available.

TABLE 1
Percentage of cases produced by CRCE

| | No anechoic foam | .With anechoic foam |
|---|---|---|
| Benign (<5 dB fade) | <1% | 6% |
| Ricean | 20% | 55% |
| Rayleigh | 60% | 25% |
| hyper-Rayleigh | 20% | 10% |
| two-ray | <1% | 4% |

### Example 1

### CRCE Fading Generation

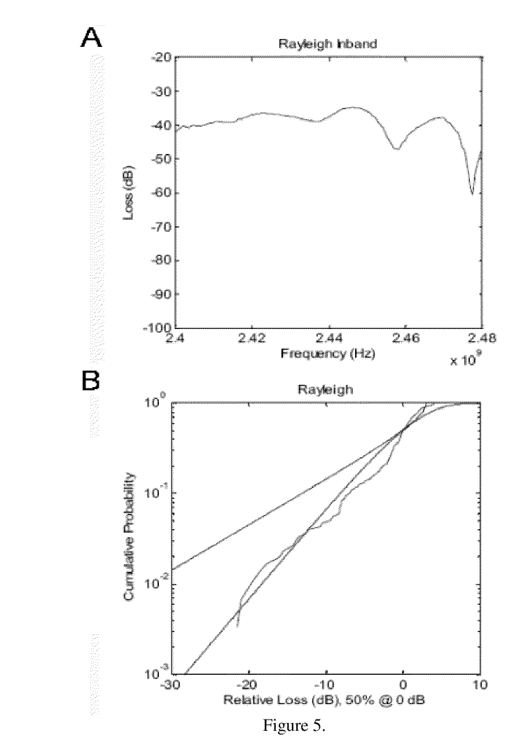

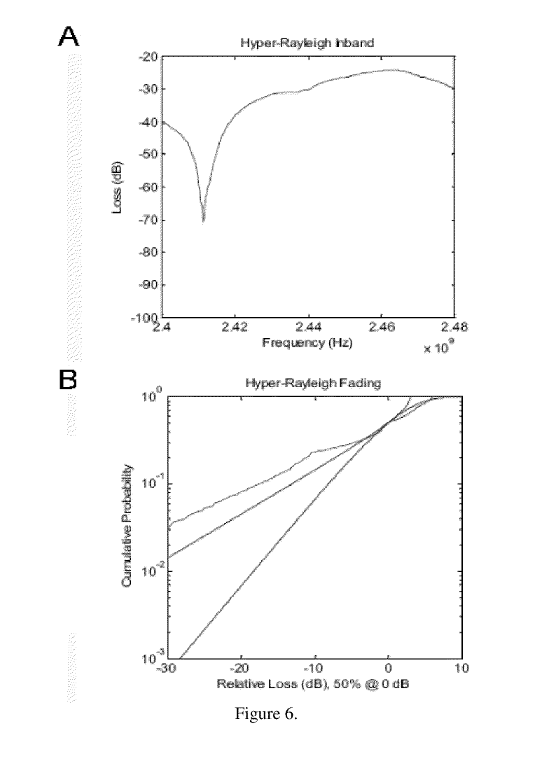

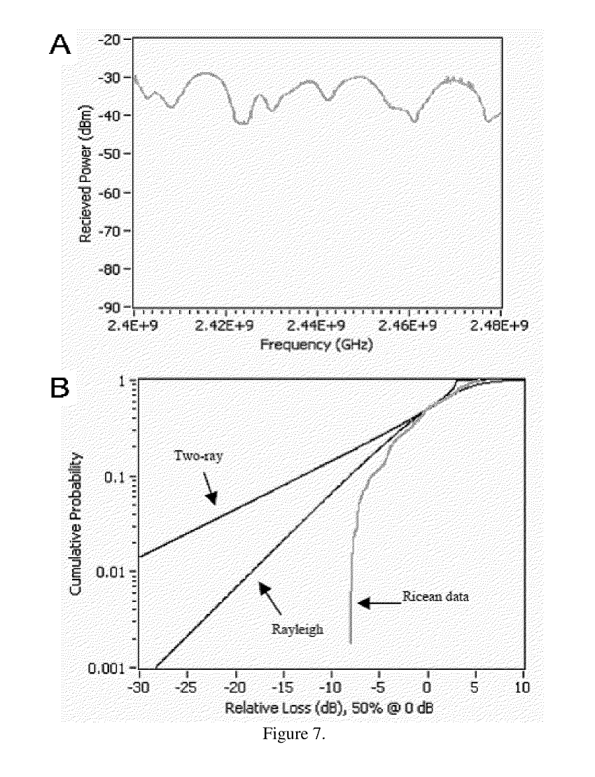

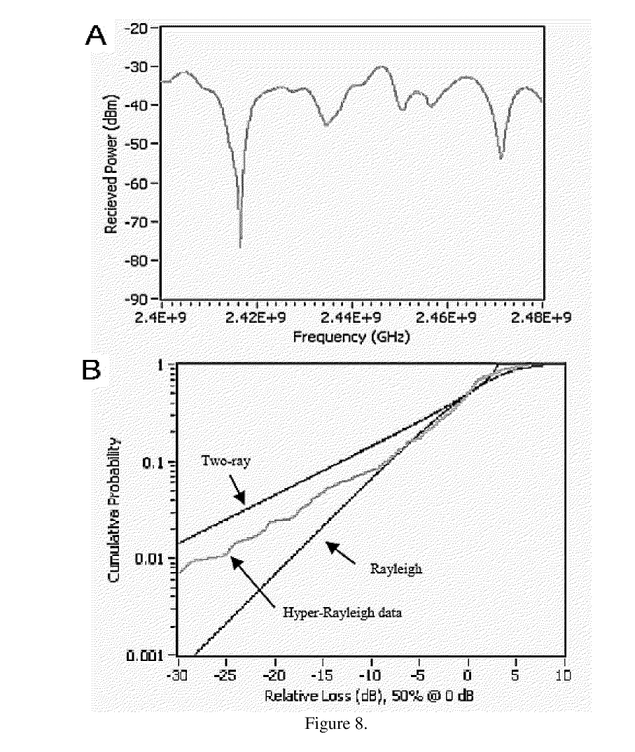

A device was created as described above using aluminum sheeting inner walls in the test chamber. A manually adjustable steel paddle was placed in the center. Antennas were mounted on platforms on opposite walls of the inner chamber. As illustrated in FIG. 4, the antennas were connected with a vector network analyzer (VNA) which swept a frequency range, providing S21 data for the band of interest (2.40-2.48 or 5.00-5.08 GHz). Data was pulled from the VNA to a custom Labview graphic user interface (GUI) on the PC, where its CDF was calculated and displayed. The data captured from this design is shown in the FIGS. 5(A)-7(B). The device is useful in generating Rayleigh fading, seen in FIGS. 6(A) and (B), hyper-Rayleigh fading, seen in FIGS. 7(A) and (B), and Ricean characteristics, seen in FIGS. 8(A) and (B). Data is displayed as in-band (left) and CDF (right), and has been taken in the 2.4 GHz ISM, band.

The data above displays the large range of fading environments accomplished through the positioning of the antennas and reflective blade, as well as the addition and subtraction of anechoic material. The chamber is able to create scenarios ranging from Ricean (K≈100) to beyond the two-ray model and maintain these scenarios until the environment is disturbed. The most severe fades were collected when reflective material was added as a sort of false floor, leading us to believe that the higher amplitude multipath waves resulting from a smaller chamber have a greater potential for creating harsh fading environments.

### Example 2

### Frequency-Selective Fading

Graphical representations of waveforms, captured by the device utilizing frequency-selective settings. As seen in FIG. 8(A), the in-band data indicate variation across the 2.40-2.48 GHz ISM band is approximately 12 dB. Statistically, this fading response exhibits Ricean behavior as illustrated in the CDF plot, seen in FIG. 8(B).

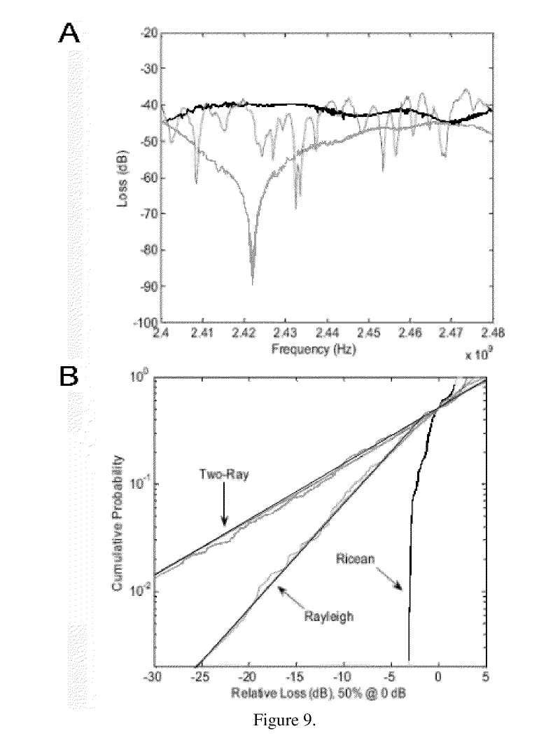

The statistical behavior of this data is highly varying depending on the position of TX antenna, and on the selected frequency. FIG. 9 shows three fading profiles from the same scan, taken from the data generated in FIGS. 5-7, each representing a different frequency. The black line displays Ricean fading, the light gray Rayleigh, and the medium gray hyper-Rayleigh. The device generates an almost benign environment across the 2.4 GHz band, with an inband variation of only 5 dB, corresponding to a high-K Ricean fading distribution. An inband variation of 30 dB and statistical behavior resembling that of the Rayleigh model. The most severe fading data is represented by the medium gray line. Here the inband variation exceeds 40 dB across the ISM band, and the statistical behavior is not only hyper-Rayleigh but closely resembles that of the worst-case, two-ray model.

The result shows repeating, discrete levels of amplitude, increased by 5 times (f=7.14 Hz). The CDF curves for both sets of data are equal and also show 7 steps. Adding more active antenna combinations further increases the number of amplitude levels and smoothness of the CDF curve. The frequency of time-varying changes may be increased to the limit of the analog output board. Output pulses are skew limited to 10 kHz. As mentioned earlier, however, the VNA is only sampling at fs=275 Hz.

Utilizing the switching antennas in conjunction with the rotating blade creates an aperiodic time-varying environment shown to exhibit Rayleigh-like behavior. This result is similar to that of operating two asynchronous spinning devices, as with the metal oscillating fan and rotating blade.

As a point of comparison, Rayleigh and two-ray theoretical models in each CDF analysis plot were analyzed. Note that for most mobile communication systems, Rayleigh is assumed to be the worst-case for analysis and that the two-ray model has been proposed as a worst-case for statically deployed sensors. The importance of understanding the fading characteristics of a channel is to better determine link margins and/or requisite transmission power. To conserve energy, minimizing the latter is desirable especially for energy constrained systems as wireless sensors. From comparing the two theoretical models, one notes that the probability of a 25 dB fade relative to the median received signal is ˜0.2% for Rayleigh channels and ˜2% for two-ray; an order of magnitude greater.

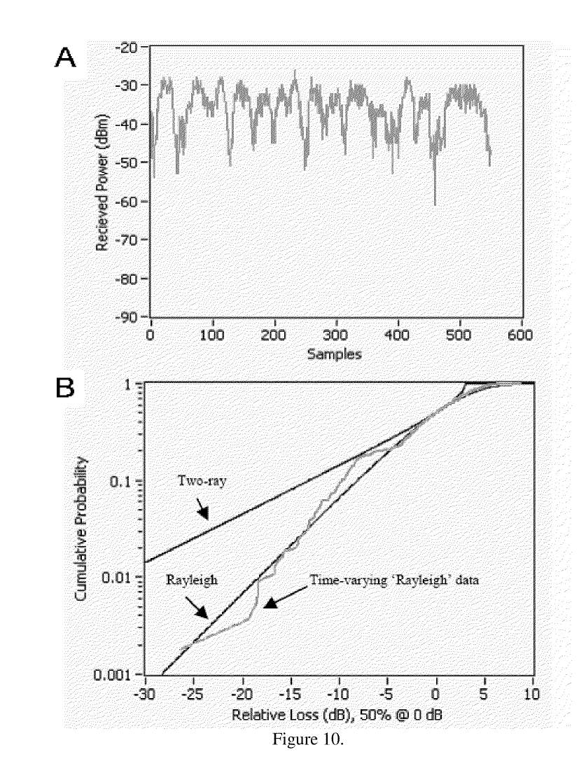

Hyper-Rayleigh fading characteristics result in inband variation exceeding 40 dB across the same ISM band, seen in FIG. 10(A). Statistically deep fade probability is greater than what the Rayleigh model would predict but still less that the two-ray model, seen in FIG. 10(B). The device disclosed allows a user to create an environment in which frequency-selective fading as severe, or more severe, than Rayleigh models, and 5 is repeatable from one test to the next. As such, different communication strategies, such as diversity antennas or coding schemes, can be tested under the same harsh conditions.

### Example 3

### Time-Selective Fading

Using a stepper motor, temporal variations are introduced in the test chamber environment with a periodic rate of 2.0 Hz. The addition of an oscillating metal fan allows for higher rate temporal effects. Operating both the stepper motor and the fan simultaneously results in an environment where the associated scattering becomes aperiodic. Time-selective fading is generated and data collected the under such test conditions, as seen in FIG. 10. This data illustrates fades of ˜20 dB over time, seen in FIG. 10(A). Statistically, this data exhibits Rayleigh-like fading, seen in FIG. 10(B). These results indicate an environment similar to a MSC. However, the similar fading results were generated in a physical design that is significantly smaller than a MSC.

Thus, the device disclosed herein enables time-selective fading at repeatable low rates (<2.0 Hz), periodic high-rates (˜25 Hz) and of aperiodic nature.

### Example 4

### Spatial-Selective Fading

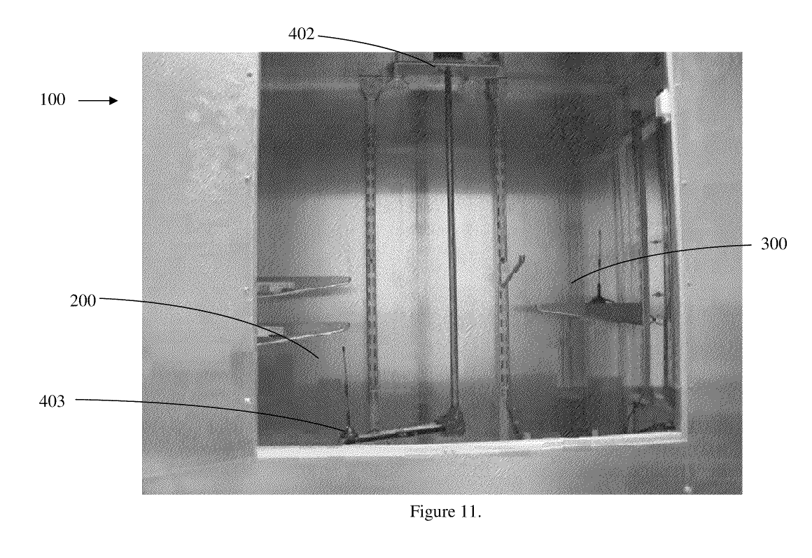

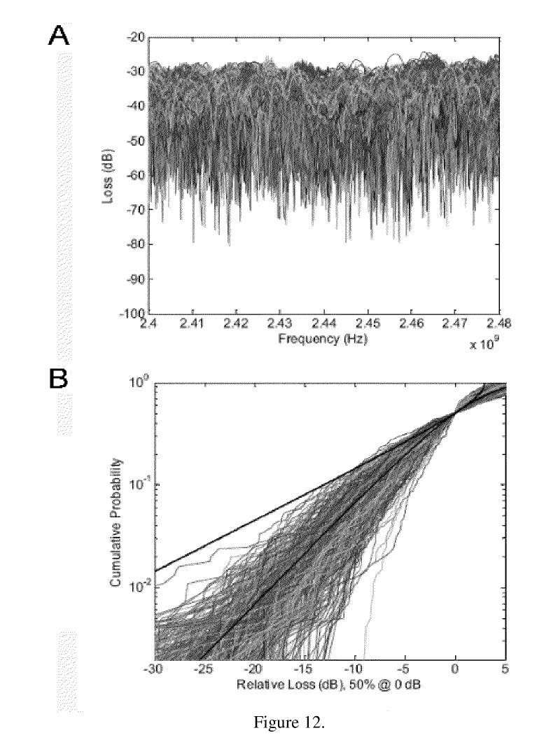

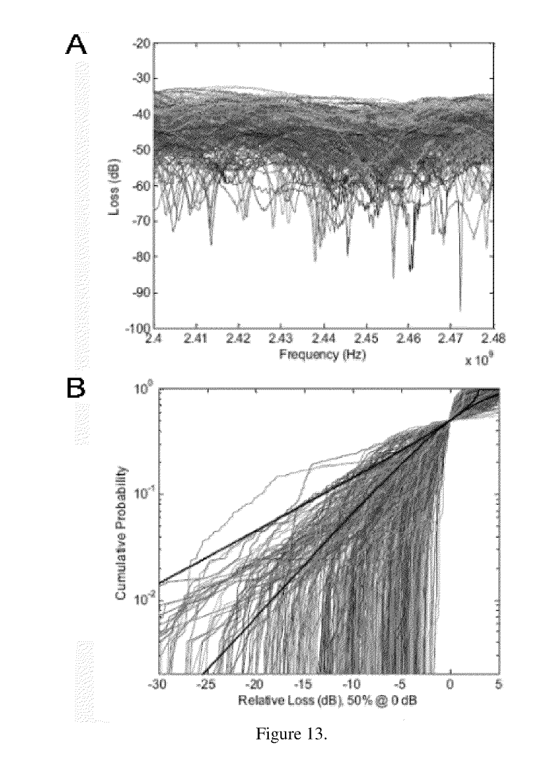

To generate spatial-dependent fading, frequency-sweep data was collected for 50 locations of the transmitting antenna around a 360° rotation. By selecting a specific frequency, the spatial-selective data (50 points) may be presented. The rotating reflective blade is replaced with an L-shaped blade, and the transmitting (or receiving) antenna is placed on the flat portion of the about 9″ away from the shaft. Using the AutoScan feature, the antenna is rotated to 50 locations around 360°, collecting frequency selective data for each, as illustrated in FIG. 11. Since the motor is stepping 7.2° at a time, each transmission location is ˜1.13″, or 0.229λ at 2.4 GHz, from the previous location. In one rotation, the maximum distance between two measurement points is ˜18″ (−1.5λ at 2.4 GHz). When the scan is complete, the GUI allows viewing a specific frequency in which for the spatially-varying fading. In addition to the choice of four separate transmitting locations, antennas may be activated simultaneously, creating multiple sources of specular waves. With four antennas, this allows 15 separate active modes of transmission, each of which has been shown to create its own unique environment. 15 modes times 50 stepper positions yields 750 separate fading scenarios. Three active antenna modes at the 50 stirrer locations (150 scenarios). In FIG. 12, shows the results of one such test, where antennas were placed on opposite sides of the blade (no LOS), and no anechoic material was added. FIG. 13 shows the results for the same test, but with a 2′×2′ section of anechoic material added to the test chamber. For the first case, the chamber is very reflective, creating a large number of multipath waves; while for the second test multipath should be minimized. FIG. 12(A) shows that these environments are all unique in where and how deeply they fade, yet FIG. 12(B) displays that all exist within a narrow range of statistical variability. The fading results range from about Rician (K<10 dB) to TWDP (K<10 dB), with just a few outliers on either end. The case in which multipath is minimized using anechoic material yields results ranging from benign environments all the way up to the two-ray model. FIG. 13(A) shows smooth changes in in-band response over the frequency range for each position. In addition, each in-band response is very similar in shape, yet highly variable in fade depth. This behavior is likely the result of having just one or two prevalent waves, which fluctuate in amplitude along with the diffuse component. FIG. 13(B) confirms this. These results indicate that high levels of multipath yield mostly Rayleigh-like scenarios, while less multipath yields a large range of sloping curves. By switching through the active antennas modes, a controlled form of time-varying multipath is created. FIG. 14 shows antennas cycling through the three combinations, switching modes every 100 ms giving a frequency of 1.43 cycles/s (f=1/(7×100 ms).

This is a significant result because it emphasizes the non-uniformity of the CRCE. Over space or time, the chamber will produce a great range of results. In this, it truly differs from reverberation chambers, where results over time and space are statistically consistent. In addition, the spatial-varying fading results have revealed insight into signal changes over a very short distance. Altering the position of a transmitting or receiving antenna by less than ¼ λ may yield highly differing levels of fading. Wireless sensors placed in high multipath environments, such as aircraft, may thus be expected to exhibit such variable behavior based on slight changes of position, antenna orientation, or objects in the environment.

### Example 5

### Electrical Interference Testing

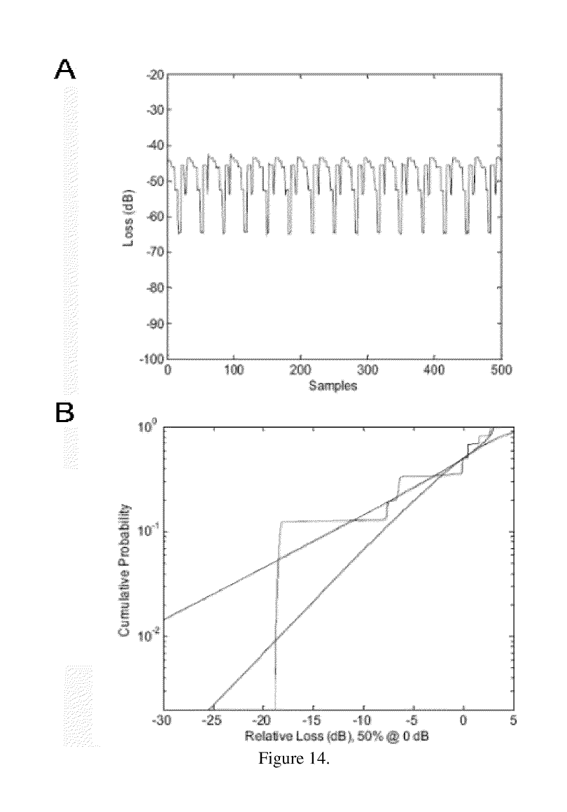

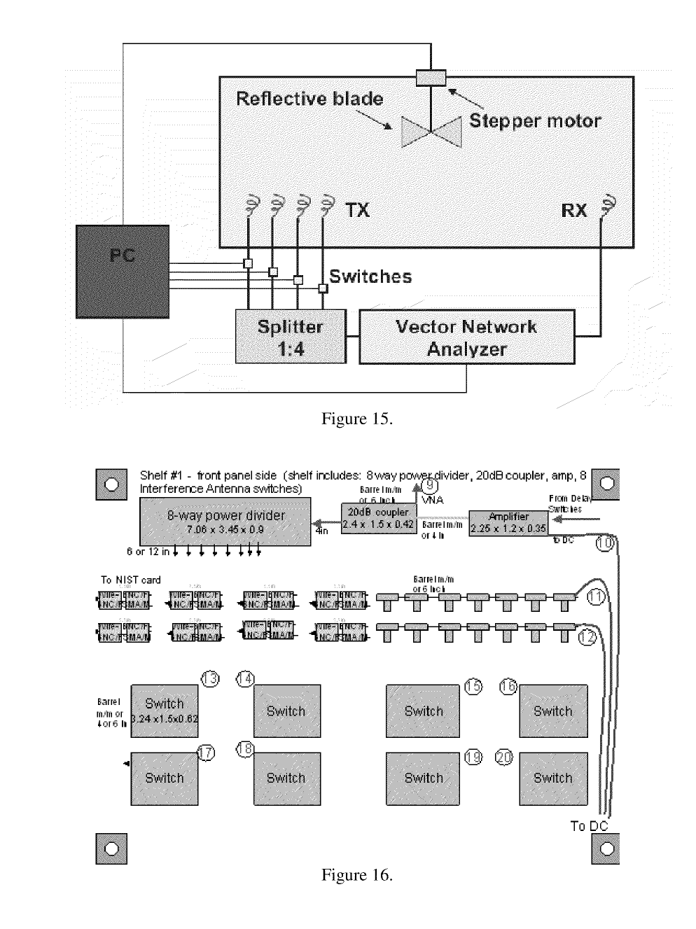

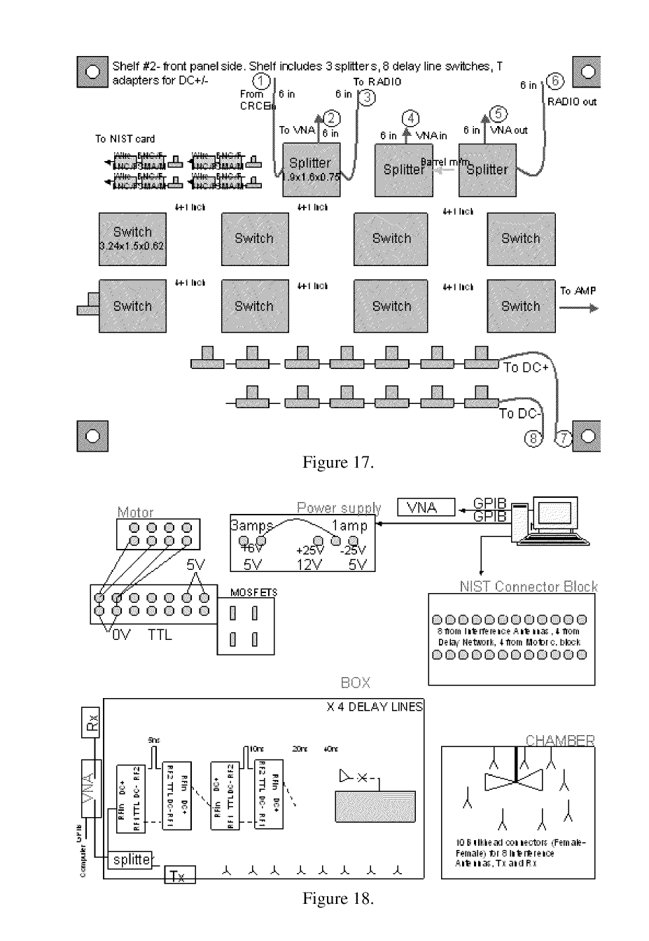

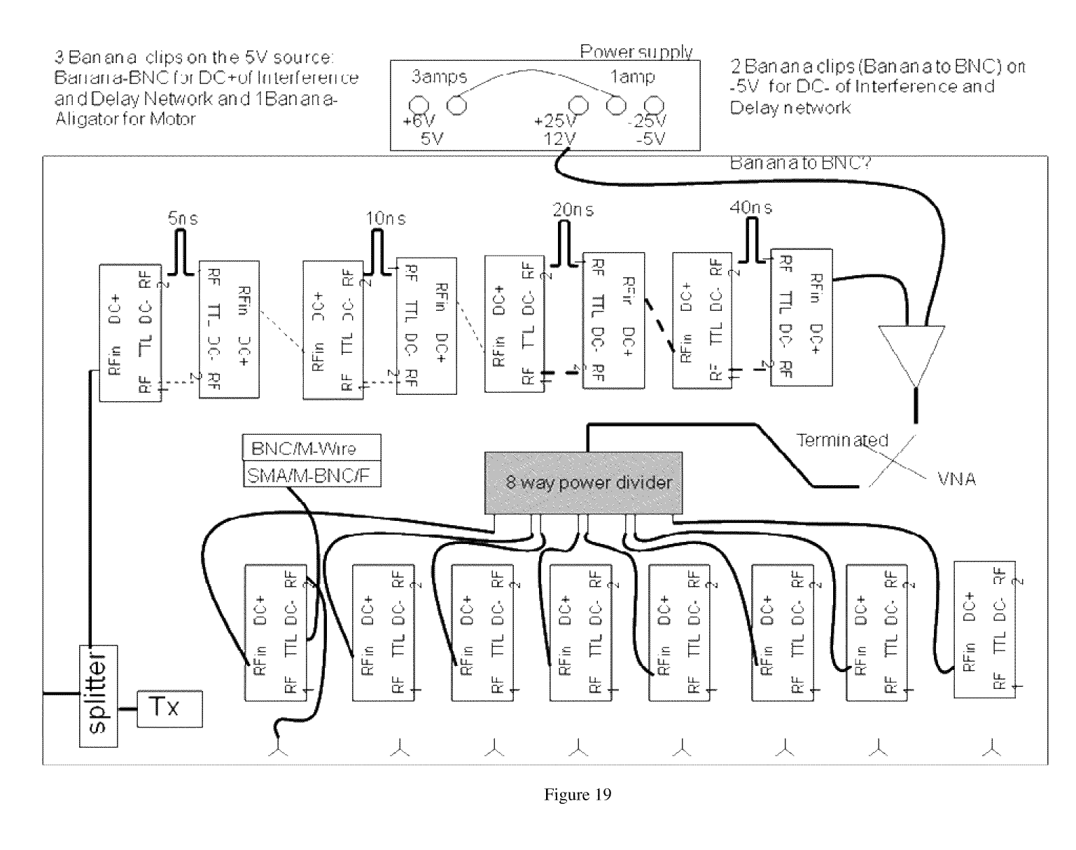

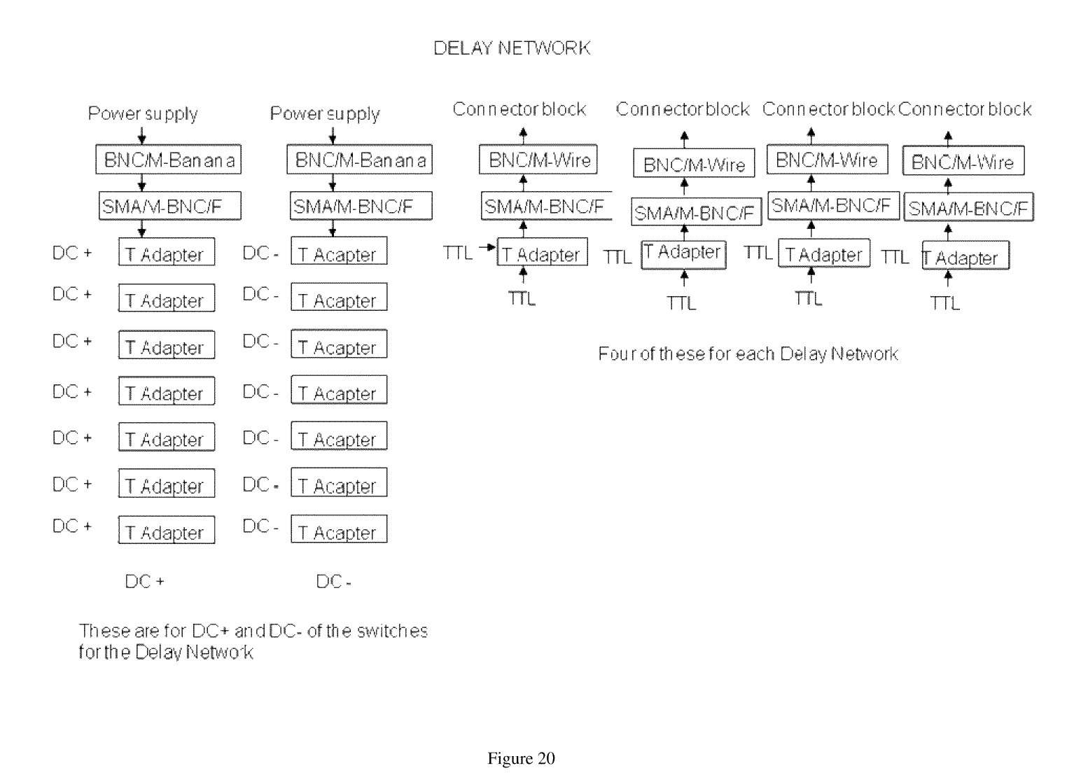

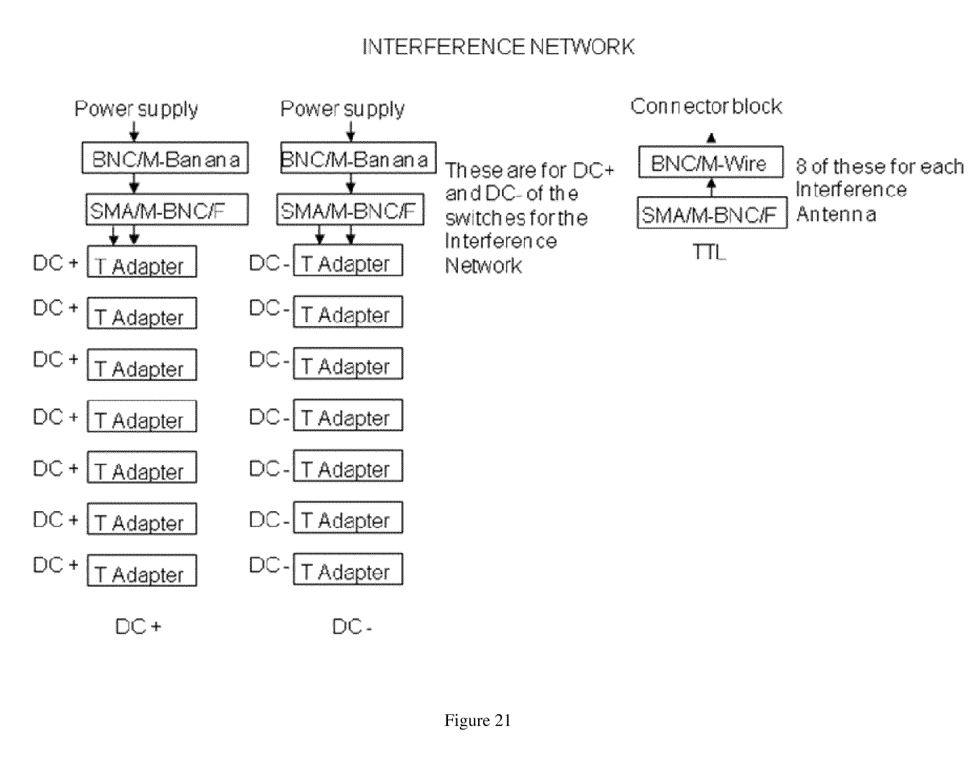

Electrical interference testing was performed by adding electrical perturbation to mechanical perturbation to test an additional means of generating creating multipath events. Multiple transmitting antennas are used to vastly increase the total number and range of fading scenarios available to the user, thus decreasing the need to open the chamber and alter the environment. In addition, time-varying fading will be much better controlled, raising the repeatability of tests, and will increase obtainable cycle rates by two orders of magnitude (up to thousands of Hertz). The CRCE seen in FIG. 15 uses an aluminum chamber with reflective blades, as described previously. The chamber also uses electrical switching arrays, as seen in FIG. 15. A 1:4 power splitter and four switching devices, controlled by the PC, directly activate and deactivate their respective transmitting antennas. The switching devices, seen in FIGS. 16-21, enable the computer to control interference transmissions, allowing rapidly changing interference within the device.

### Example 6

### Antenna Transmission Characterization

Typical wireless sensor hardware (per IEEE 802.15.428) employs 3 MHz channels. The array tested is an electrically configurable element transmit array, described in Table 2, with a re-radiation link noise bandwidth of approximately 400 kHz. For high loss environments, scan time can be increased to enable time-averaging of the signal and improved SNR.

TABLE 2
Transmission characteristics of electrically
configurable element transmit array

| | | | |
|---|---|---|---|
| Parameter | Units | Value | Comments |

Interrogation Link

| | | | |
|---|---|---|---|
| Transmitter Frequency | GHz | 2.4 | Unlicensed ISM Baud |
| Transmit Power | Watts | 1 | Max per FCC 15.247³⁰ |
| | dBm | 30 | |
| Transmit Antenna Gain | dBi | 0 | No directivity assumed |
| | | | (worst-case) |
| EIRP | dBm | 30 | |
| Minimum Received Power | dBm | −30 | Expected minimum |
| | | | operating power (over |
| | | | 15 dB lower than |
| | | | comparable approaches⁵) |
| Allowable Path Loss | dB | 60 | >30 dB greater than |
| | | | existing reports¹⁶ |

Reradiation Link

| | | | |
|---|---|---|---|
| Minimum Received | dBm | −30 | From interrogation link |
| Interrogation Power | | | |
| Conversion Loss | dB | 30 | Based on prototype data |
| | | | and antenna efficiencies |
| Transmitter Frequency | GHz | 4.8 | Doubling effect of RRS |
| Transmit Power | dBm | −60 | |
| Receive Antenna Gain | dBi | 10 | Employing spatial and |
| | | | frequency diversity |
| Minimum Received Power | dBm | −120 | 20 dB lower than typical |
| | | | wireless sensor hardware |
| Allowable Path Loss | dB | 60 | |

Based on component-level data, link loss for the interrogation and re-radiation links can be up to 60 dB each; far greater than what is allowable in competing, low-power technologies, such as RFID.

The test array was placed within the test chamber of the disclosed device. Environment modeling characteristics of the disclosed device are summarized in Table 3.

TABLE 3
Modeling capabilities of an embodiemtn of the
device, used for wireless device testing

| Time/Frequency Fading | |
|---|---|
| Capabilities | Measurement Capabilities |
| Fade free environment | Frequency-selective fading |
| Ricean fading (K = 1, | Time-selective fading |
| 2, 3, 5 & 10) | Signal to Interference Ratio |
| Rayleigh fading | Characterization of Time/Frequency |
| Hyper-Rayleigh fading | fading |
| Two-ray fading | Spatial/frequency diversity benefits |
| Selectable 10, 20, 30 | |
| and 40 dB fades | |

For test of the proposed sensor node, the array was placed in the device and interrogated via an external source connected to a patch antenna within the chamber. The link characteristics between the interrogator and node antennas collected through vector network analyzer measurements conducted through couple paths. An automated test protocol was developed to sweep the interrogator signal source, note the performance of the node (e.g., conversion efficiency, robustness to multipath), capture the channel characteristics, and configure the next test scenario.

In the preceding specification, all documents, acts, or information disclosed does not constitute an admission that the document, act, or information of any combination thereof was publicly available, known to the public, part of the general knowledge in the art, or was known to be relevant to solve any problem at the time of priority.

While there has been described and illustrated specific embodiments of a wireless test device, it will be apparent to those skilled in the art that variations and modifications are possible without deviating from the broad spirit and principle of the present invention. It is also to be understood that the following claims are intended to cover all of the generic and specific features of the invention herein described, and all statements of the scope of the invention which, as a matter of language, might be said to fall therebetween. Now that the invention has been described.

What is claimed is:

1. An apparatus comprising:
a test chamber;
a device adapted to generate multipath fading within the test chamber, comprising at least one device selected from the group consisting of at least one electromagnetically reflective blade pivotally attached to the test chamber, at least one switching array, and a plurality of electrical switching arrays;
a plurality of antenna electromagnetically bound within the test chamber, further comprising:
at least one signal transmission antenna or connection port for accepting a signal transmission antenna;
at least one receiving antenna or connection port for accepting a receiving antenna;
at least one delay transmission antenna or connection port for accepting a delay transmission antenna;
a signal detection device, electrically connected to the at least one receiving antenna.

2. The apparatus of claim 1, further comprising at least one interference transmission antenna or connection port for accepting an interference transmission antenna.

3. The apparatus of claim 1, further comprising a motor attached to the at least one reflective blades selected from the group consisting of a shaded pole AC induction motor, split-phase capacitor AC induction motor, AC synchronous motor, stepper DC motor, brushless DC motor, coreless DC motor, brushed DC motor, singly-fed electric motor, and doubly-fed electric motor.

4. The apparatus of claim 3, wherein the motor is adapted to rotate the stirrer at a continuous speed from 0.1 to 2.0 Hz.

5. The apparatus of claim 3, wherein data acquisition from the signal detection device is controlled by a computer.

6. The apparatus of claim 1, wherein the signal detection device is a vector network analyzer or vector signal analyzer.

7. The apparatus of claim 3, wherein the rotation and position of the at least one reflective blade is controlled by a computer.

8. The apparatus of claim 1, wherein the test chamber is selected from the group consisting of an electromagnetically reflective chamber; an electromagnetically absorbent chamber, and a RAM coated chamber.

9. The apparatus of claim 1, wherein the at least one delay transmission antenna is electronically connected to a delay line selected from the group consisting of a coaxial line, triaxial line, twin-axial line, biaxial line, and semi-rigid line.

10. The apparatus of claim 1, wherein the at test chamber has dimensions 7.3λ×4.8λ×7.3λ for a selected electromagnetic wave.

11. The apparatus of claim 1, further comprising at least one movable object within the chamber selected from the group consisting of a movable electromagnetically reflective obstacle, an oscillating fan, a wireless test device and a rotating transmission antenna holder selected from the group consisting of an L-shaped armature and a platform.

12. The apparatus of claim 11, further comprising at least two objects arranged in the chamber, wherein the objects are sequentially movable during the apparatus operation.

13. The apparatus of claim 1, wherein the test chamber is selected from the group consisting of a stand-alone fully-shielded bench-top structure with outer shielding and an in-situ bench-top structure without outer shielding.

14. The apparatus of claim 1, further comprising a plurality of transmission antenna, electrically attached to a power splitter and controlled by a computer, wherein the transmission antenna supply electrical interference within the test chamber.

15. The method of characterizing an electromagnetic communication device, comprising the steps of:
providing a test apparatus further comprising:
a test chamber;
at least one electromagnetically reflective blade pivotally attached to the test chamber;
a signal detection device, electrically connected to the at least one receiving antenna;
providing a plurality of antenna in the test apparatus, wherein the plurality of antenna further comprise at least one transmitting antenna, at least one delay transmission antenna and at least one receiving antenna;
creating a fading environment selected from the group consisting of Ricean fading, Rayliegh fading, hyper-Rayliegh fading, two-ray fading, 10 dB fading, 20 dB fading, 30 dB fading, 40 dB fading, and a fade free environment;
generating an electromagnetic signal from the transmitting antenna to the receiving antenna; and
collecting electromagnetic signal data.

16. The method of claim 15, wherein the test chamber is selected from the group consisting of an electromagnetically reflective chamber; an electromagnetically absorbent chamber, and a RAM coated chamber.

17. The method of claim 15, wherein the collected data is selected from the group consisting of bit error rate, frame error rate frequency-selective fading, time-selective fading, signal-to-interference ratio, time/frequency fading, spatial diversity benefits, response of equalization algorithms, power control algorithms, and frequency diversity benefits.

18. The method of claim 15, further comprising providing at least one movable object within the test chamber.

19. The method according to claim 18, wherein the at least one movable object is selected from the group consisting of a movable platform, an oscillating fan, and a wireless test device.

20. The method according to claim 18, wherein the at least one moving object within the chamber is moved continuously during a measurement operation.

21. The method of claim 15, further comprising positioning the at least one reflective blade at a designated position to allow for frequency-selective scanning.

22. The method of claim 15, further comprising generating electrical interference from a plurality of transmission antenna, wherein the antenna are electrically connected to a power splitter.
